(19) United States
(12) Patent Application Publication
(10) Pub. No.: US 2011/0146163 A1
(43) Pub. Date: Jun. 23, 2011

(54) MOUNTING ASSEMBLY FOR SELECTIVELY SECURING A DEVICE TO A STRUCTURE AND ASSOCIATED METHOD

(75) Inventors: Igor Naroditsky, Brooklyn, NY (US); Chin-Hung Jwo, Mt. Sinai, NY (US)

(73) Assignee: SYMBOL TECHNOLOGIES, INC., HOLTSVILLE, NY (US)

(21) Appl. No.: 12/640,504

(22) Filed: Dec. 17, 2009

(51) Int. Cl. F16L 3/08; F16L 3/00; E04B 1/38

(52) U.S. Cl. 52/27; 248/70; 52/745.21

(57) ABSTRACT

The present invention provides generally a mounting assembly for selectively securing a device, such as an RFID reader, an access point (e.g. a wireless router), or the like, to a structure, such as a wall, a ceiling, or the like, and an associated method. The mounting assembly includes at least a bracket, a base plate, and one or more retention members. More specifically, the present invention provides a mounting assembly for selectively securing a device to a structure, wherein the mounting assembly provides adequate ventilation to the device, has a footprint that is no larger than that of the device, may be used in a variety of directional configurations, and is simple to install and operate, among other advantages.

### FIELD OF THE INVENTION

The present invention relates generally to a mounting assembly for selectively securing a device to a structure and an associated method. More specifically, the present invention relates to a mounting assembly for selectively securing a device to a structure with the mounting assembly including a bracket, a base plate, and one or more screws.

### BACKGROUND OF THE INVENTION

A variety of mounting assemblies for selectively securing an electronic device, such as a radio frequency identification (RFID) reader, an access point (e.g. a wireless local area network (WLAN) router), or the like, to a structure, such as a wall, a ceiling, or the like, have been developed, manufactured, and distributed and are well known to those of ordinary skill in the art. These mounting assemblies, however, suffer from a number of shortcomings. Many of these mounting assemblies do not provide adequate ventilation to the electronic device, which is problematic as such electronic devices typically generate and radiate a significant amount of heat, especially through the back portion thereof. Many of these mounting assemblies have a footprint that is significantly larger than that of the electronic device, creating space consideration and aesthetic problems. Many of these mounting assemblies may only readily be used in one directional configuration, creating access and wiring problems. Finally, many of these mounting assemblies are simply difficult to install and operate. They leave much to be desired in terms of design and performance. Thus, what is still needed in the art is an improved mounting assembly for selectively securing a device to a structure and an associated method.

### BRIEF SUMMARY OF THE INVENTION

In one exemplary embodiment, a mounting assembly for selectively securing a device to a structure includes a bracket; a base plate selectively coupled to the bracket, wherein the base plate and the bracket are coupled together such that an air space is defined there between; one or more screws each comprising a head portion and an elongated shaft member, wherein the elongated shaft member selectively engages an opening in the bracket to selectively engage to a structure thereby securing the bracket to the structure, and wherein the head portion selectively engages the base plate thereby coupling the base plate to the bracket; and a device is attached to or integrally formed with the base plate. The bracket may include one or more arms configured and positioned such that convective heat dissipation occurs between the base plate and the structure. The base plate may include one or more grooves configured and positioned to slidingly receive the one or more spacers of the bracket. The base plate may include one or more spacers configured and positioned to further define the air space between the base plate and the bracket. The bracket may include one or more grooves configured and positioned to slidingly receive the one or more spacers of the base plate. The bracket may include a latch mechanism and the base plate defines a corresponding catch mechanism for selectively holding the base plate in position relative to the bracket. Alternatively, the base plate may include a latch mechanism and the bracket defines a corresponding catch mechanism for selectively holding the base plate in position relative to the bracket. The bracket assembly and the base plate each may include an alignment mark collectively permitting a determination of the relative position of the base plate relative to the bracket. The head portion of the one or more screws may selectively engage an aperture manufactured into the base plate thereby coupling the base plate to the bracket. The bracket may be secured to the structure such that the device is held in a plurality of orientations based upon positioning of the device on the bracket. The device may include at least one of cable ports, power ports, or antennas disposed on one or more sides of the device, and wherein the orientation of the plurality of orientations is selected based on any of the cable ports, the power ports, or the antennas relative to characteristics associated with the surface. An orientation of the device may be switchable to any of the plurality of orientations subsequent to the bracket being secured to the structure. The bracket may be sized and shaped such that no portion of the bracket protrudes beyond a perimeter of the base plate when the base plate is coupled to the bracket. The bracket may include one or more stops through which the one or more screws engages the bracket, the one or more stops determining a degree to which the head portion of the one or more screws protrudes above a surface of the bracket. A load associated with the device may be substantially maintained by the one or more screws when the device is selectively engaged to the bracket. The bracket may be configured to define the air space thereby providing convective heat dissipation between the device and the surface, and wherein the bracket is constructed of a plastic material. The bracket may include a latch mechanism and the base plate defines a corresponding catch mechanism for selectively holding the base plate in position relative to the bracket, and wherein the bracket provides substantially no load bearing of the device.

In another exemplary embodiments, a method for selectively securing a device to a structure includes securing a bracket to a structure utilizing one or more screws each including a screw head, wherein each of the screw heads is configured to extend out a portion from a surface of the bracket; positioning a device including a base plate with one or more openings disposed adjacent to the one or more screws; engaging the device to the screw heads; and securing the device to the bracket; wherein the base plate and the bracket are coupled together such that an air space for convective heat transfer of the device is defined there between. The method may further include disengaging the device from the bracket; repositioning the device in a different orientation to the bracket; engaging the device to the screw heads; and securing the device to the bracket.

In yet another exemplary embodiment, a device includes a plurality of sides; a base plate disposed to the plurality of sides and including a connection mechanism; a bracket secured to a surface with one or more screws, wherein each of the one or more screws include a screw head that is offset from a surface of the bracket through a raised portion on the bracket; wherein the connection mechanism is selectively engageable to the bracket through the screw heads in a plurality of orientations; wherein at least one side of the plurality of sides comprises a cable port such that an orientation of the plurality of orientations is selected based upon a location of the cable port; and wherein the base plate and the bracket are coupled together such that an air space for convective heat transfer is defined there between.

### BRIEF DESCRIPTION OF THE DRAWINGS

The present invention is illustrated and described herein with reference to the various drawings of exemplary embodiments, in which like reference numbers are used to denote like assembly components/method steps, as appropriate, and in which:

FIGS. 1-4 are front perspective views of a mounting assembly with a device selectively secured to a structure in various different orientations;

FIGS. 5 and 6 are back perspective diagrams illustrating the mounting assembly of the present invention, highlighting an associated bracket when disassembled from an associated base plate of the device;

FIGS. 7 and 8 are front perspective diagrams illustrating the mounting assembly of the present invention, highlighting securing the associated bracket to the structure;

FIGS. 9 and 10 are front perspective diagrams illustrating an exemplary attachment operation of the device to the bracket;

FIGS. 11 and 12 are front perspective diagrams illustrating an exemplary attachment operation of the device on the bracket in an opposite orientation as shown in FIGS. 9 and 10;

FIGS. 13 and 14 are back perspective diagrams illustrating the mounting assembly of the present invention, highlighting the associated bracket (with a portion thereof cut away for clarity) when detached and attached from the associated base plate of the device;

FIG. 15 is a back perspective diagram illustrating the mounting assembly of the present invention, highlighting the associated bracket when detached from the associated base plate of the device;

FIG. 16 is a front perspective diagram illustrating the mounting assembly of the present invention, highlighting the device (with a portion thereof cut away for clarity) with the base plate engaged to the bracket; and

FIGS. 17 and 18 are back perspective diagrams illustrating the mounting assembly of the present invention, highlighting the latch mechanism of the associated bracket attaching to the associated base plate of the device.

### DETAILED DESCRIPTION OF THE INVENTION

The present invention provides generally a mounting assembly for selectively securing a device, such as an electronic device or a non-electronic device, including, but not limited to an RFID reader, an access point (e.g. a wireless router), or the like, to a structure, such as a wall, a ceiling, or the like, and an associated method. More specifically, the present invention provides a mounting assembly for selectively securing the device to a structure, wherein the mounting assembly provides adequate ventilation to a device that is electronic, has a footprint that is no larger than that of the device, may be used in a variety of directional configurations, and is simple to install and operate, among other advantages. Other advantages are utilization of same screw/screws for mounting the bracket and the device offering high load carried capacity, elimination of hole locating template and blind self alignment. It will be readily apparent to those of ordinary skill in the art that the mounting assembly of the present invention may be used to secure any type of device (electronic or non-electronic) to any type of structure and any and all exemplary devices and structures illustrated and described herein are intended to be non-limiting.

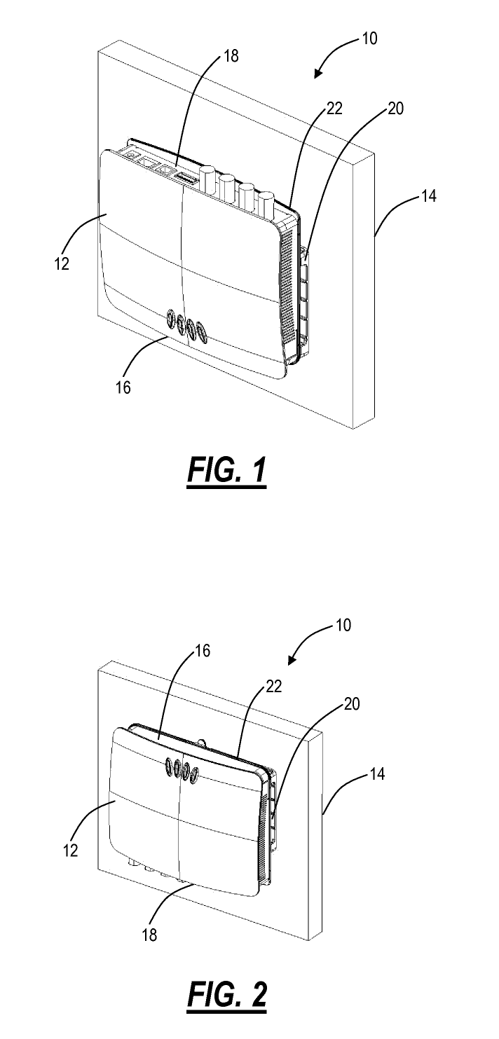

Referring to FIGS. 1-4, in various exemplary embodiments, a mounting assembly 10 is illustrated in front perspective views with a device 12 selectively secured to a structure 14. In this exemplary embodiment, the device 12 includes a top side 16 with visual indicators such as light emitting diodes (LEDs) and cabling ports, antennas, and the like located at a bottom side 18. Examples of the device 12 are, but not limited to, an RFID reader, an access point (e.g. a wireless router), a video camera, or any other electronic or non-electronic device. Advantageously, the mounting assembly 10 allows the device 12 to securely mount to the structure 14 in a variety of different mounting orientations, i.e. multidirectional mounting of the device 12. Each of FIGS. 1-4 illustrate the device 12 is a different mounting orientation with respect to the top side 16 and the bottom side 18 of the device 12. Note, the device 12 may be mounted in different orientations as required for cabling access, antenna coverage, video camera position, and/or the like. Thus, the mounting assembly 10 can support any such orientation. Further, the top side 16 and the bottom side 18 are labeled as such for illustration purposes herein, and those of ordinary skill in the art will recognize these may be front side, rear side, back side, first side, etc., i.e. the top side 16 and the bottom side 18 are labeled as such as relative labels of particular sides of the device 12. The structure 14 may include a wall, ceiling, or the like, and the device 12 may be mounted to the structure 14 and the device may be oriented on the assembly to position the top side 16 and the bottom side 18 in different orientations. The mounting assembly 10 includes a bracket 20 disposed between the device 12 and the structure and a base plate 22 disposed on a bottom side of the device 12. The bracket 20 and the base plate 22 are described herein in subsequent FIGS. In an exemplary embodiment, the bracket 20 is sized and shaped such that no portion of the bracket 20 protrudes beyond a perimeter of the base plate 22 when the base plate 22 is coupled to the bracket 20.

FIG. 1, for example, illustrates the device 12 with the bottom side 18 facing upwards and the top side 16 facing downwards as may be the case if cable access is required from above (e.g. from a ceiling) or if antennas on the device 12 are required to face upwards. Note, in this example, the top side 16 and the bottom side 18 are labeled as such for illustration purposes with the top side 16 including the visual indicators and the bottom side 18 including cabling ports and/or antennas. The visual indicators, cabling ports, antennas, and the like can be on any side of the device 12. Further, these items could be on a top side and/or a bottom side of the device 12. The present invention contemplates any such configuration of the device 12 and the labeling in FIGS. 1-4 is shown merely for illustration purposes of exemplary embodiments. FIG. 2, for example, illustrates the device 12 with the top side 16 facing upwards and the bottom side 18 facing downwards as may be the case if cable access is required from below, etc. FIGS. 3 and 4, for example, illustrate the device 12 with the top side 16 and the bottom side 18 facing to the right and left of the structure 14. Specifically, FIGS. 1 and 2 illustrate a horizontal configuration of the top side 16 and the bottom side 18, and FIGS. 3 and 4 illustrate a vertical configuration of the top side 16 and the bottom side 18. The present invention contemplates other directional configurations as well as required for the device 12 and the structure 14. In an exemplary embodiment, the bracket 20 may be mounted to the surface 14 thereby supporting either configuration in FIGS. 1-2 and 3-4 without remounting the bracket.

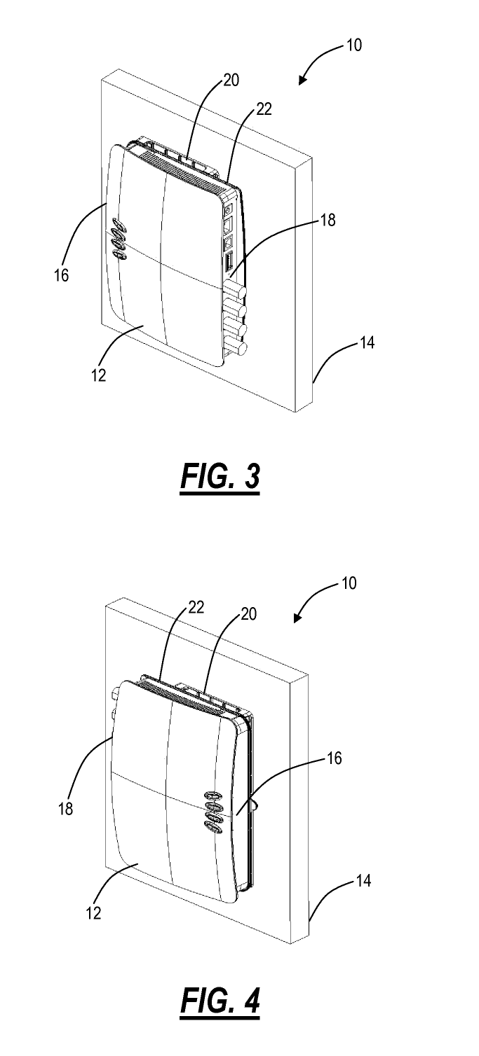

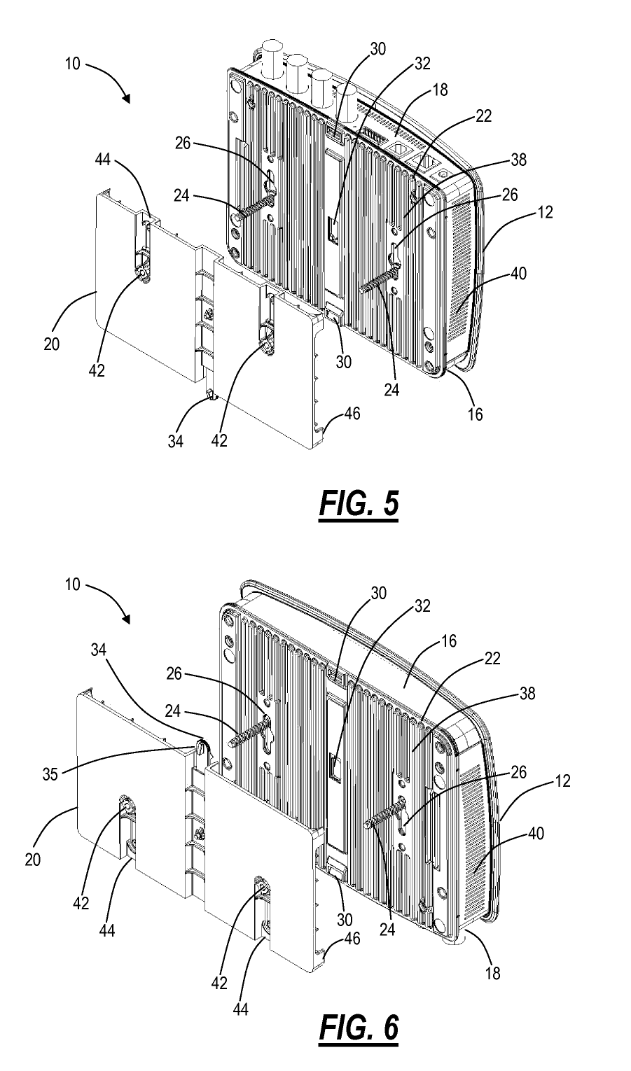

Referring to FIGS. 5 and 6, in exemplary embodiments, back perspective diagrams illustrate the mounting assembly 10 of the present invention, highlighting the associated bracket 20 when disassembled from the associated base plate 22 and the device 12. FIG. 5 illustrates the configuration of FIG. 1 with the bottom side 18 facing upwards, and FIG. 6 illustrates the configuration of FIG. 2 with the bottom side 18 facing downwards. FIGS. 5 and 6 illustrate both the bracket 20 and the device 12 in different orientations. The mounting assembly 10 supports different orientations of the device 12 without changing the orientation/mounting of the bracket 20 as is described in further detail below. The mounting assembly 10 includes the bracket 20, the base plate 22, and screws 24. The bracket 20 is adapted to be secured to the structure 14 utilizing the screws 24. The screws 24 are adapted to engage openings 26 in the base plate 22 to hold the device 12 to the structure 14. FIGS. 5 and 6 illustrate the screws 24 engaged within the openings 26, and subsequent FIGS. 7 and 8 illustrate mounting the bracket 20 with the screws 24 secured to the structure 14. The mounting assembly 10 resolves several issues frequently encountered during installation of directly wall mountable equipment such as the device 12. First, no template is needed for attaching the bracket to the wall, i.e. the wall bracket serves as a template. Solid engagement between the device 12 with the bracket 20 may be provided by a predetermined screw height limited by the screw stops under the screw head (illustrated in FIGS. 7 and 8). Also, no screws or tools are required to realign the device 12, but rather the device 12 may be realigned to the bracket by releasing the snap and reorient the device 12. Further, the bracket 20 does not carry the majority of the load associated with the device 12; rather the screws 24 carry a substantial majority of the load of the device 12. The bracket 20 optimized thermal performance of the device 12 that is electronic by defining a space between the device 12 and the structure 14 for airflow.

The base plate 22 is illustrated on the bottom side of the device 12. The base plate 22 includes the openings 26 that are dimensioned to selectively engage screw heads of the screws 24. The openings 26 are generally an aperture, groove, notch, slit, and/or slot in the base plate 22. Exemplary configurations of the openings 26 can include a key hole, a bi-directional key hole, a four-way key hole, a multi-directional key hole, a varying width opening, and the like. Those of ordinary skill in the art will recognize the openings 26 contemplate any mechanism capable of receiving the screw heads and transferring load from the device 12 to the screws 24. In an exemplary embodiment, the openings 26 include two openings spaced apart from one another and each opening 26 at approximately a mid point between the top side 16 and the bottom side 18 on the base plate 22. The base plate 22 may further include notches 30 adapted to receive the latch 34 in the bracket 20. The notch 30 and the latch 34 may provide a snap and secure/release configuration between the bracket 20 and the base plate 22. The latch 34 includes a snap rib 35. The function of the snap rib 35 is to limit deflection of the latch 34 when unit is engaged and disengaged from the bracket 20, thus preventing its breakage. The snap rib 35 acts as a hard stop, pressing against a wall in the notch 30 when the latch 34 is deflected. Note, the present invention contemplates other variations for engaging and disengaging the bracket 20 from the base plate 22. In an exemplary embodiment, the base plate 22 includes a heat sink 38 and the device 12 includes air flow vents 40 disposed around the sides of the device 12. The base plate 22 may include metal, and may be integrally formed with the device 12. Additionally, the base plate 22 may include an access port 32 for testing or other access to the device 12.

The bracket 20 includes fastener openings 42 adapted to receive screw threads from the screws 24 to mount the bracket 20 to the structure 14. In an exemplary embodiment, the fastener openings 42 include two openings spaced apart from one another and each fastener opening 42 at approximately a mid point on the bracket 20. The fastener openings 42 are located on the bracket 20 opposing the openings 26 in the base plate 22. Note, the present invention contemplates one or more openings 26, 42 as required for mounting the bracket 20 and maintaining the device 12, e.g. one screw 24, three screws 24, etc. Two screws 24 may provide sufficient load handling capacity for various devices 12 as well as preventing pivoting of the device 12 on the bracket 20. The bracket 20 is configured to define an open space between the device 12 that is electronic and the structure 14 for air flow to properly ventilate the device 12. As such, the channel 44 and various guide ribs 46 from the bracket 20 abut the base plate 22 thereby defining an open space when the device 12 is engaged to the bracket 20. Since a primary function of the bracket 20 is to separate the base plate 22 from the structure 14 to provide a space for heat transfer, the bracket 20 may be constructed of a plastic material or the like, i.e. the bracket 20 does not have to be constructed of a rigid material since the load of the device 12 is handled primarily by the screws 24 as described herein.

Referring to FIGS. 7 and 8, in exemplary embodiments, front perspective diagrams illustrate the mounting assembly 10 of the present invention, highlighting securing the associated bracket 20 to the structure 14. FIG. 7 illustrates a first stage of securing the bracket 20 to the structure 14 and FIG. 8 illustrates a second stage with the bracket 20 secured to the structure 14. Specifically, the screws 24 are utilized to secure the bracket 20 to the structure 14. Each of the screws 24 includes a screw head 50 disposed to an elongated shaft member 52 which may include threads to secure the screw 24 to the structure 14. The screw head 50 can include a flat or slotted surface, a Phillips head, a hex socket or Allen head, or any other drive mechanism to apply torque to the screw head 50 and member 52 to drive the screw 24 into the surface. The screw head 50 is substantially larger in diameter than the fastener openings 42 in the bracket and substantially smaller in diameter than the openings 26 in the base plate 22. As such, the screws 24 perform a dual function of securing the bracket 20 to the surface and of maintaining the load of the device 12 through the openings 26.

In FIG. 7, the bracket 20 is placed at a desired location on the structure 14, and the screws 24 are positioned at the fastener openings 42 and driven into the structure 14. FIG. 8 illustrates the screws 24 fully engaged in the structure 14. As described above, the fastener openings 42 are disposed within the channel 44 in the bracket. Additionally, the fastener openings 42 include a raised portion 54 that stops the screws 24 such that a portion of the screw head 50 extends out from the bracket 20, i.e. the raised portion 54 determines a degree to which the screw head 50 protrudes above a surface of the bracket 20. By protruding above the bracket 20, the portion of the screw head 50 is able to engage the openings 26 in the base plate thereby securing the device 12 to the bracket 20. The bracket 20 further includes one or more anti-rattling arms 56 to prevent rattling and to provide stabilization of the device 12 on the bracket 20. In an exemplary embodiment, the anti rattling arms 56 are contacting the base plate 22 while the base plate 22 is engaged to the bracket 20 and this contact providing a force keeping the device 12 stabilized.

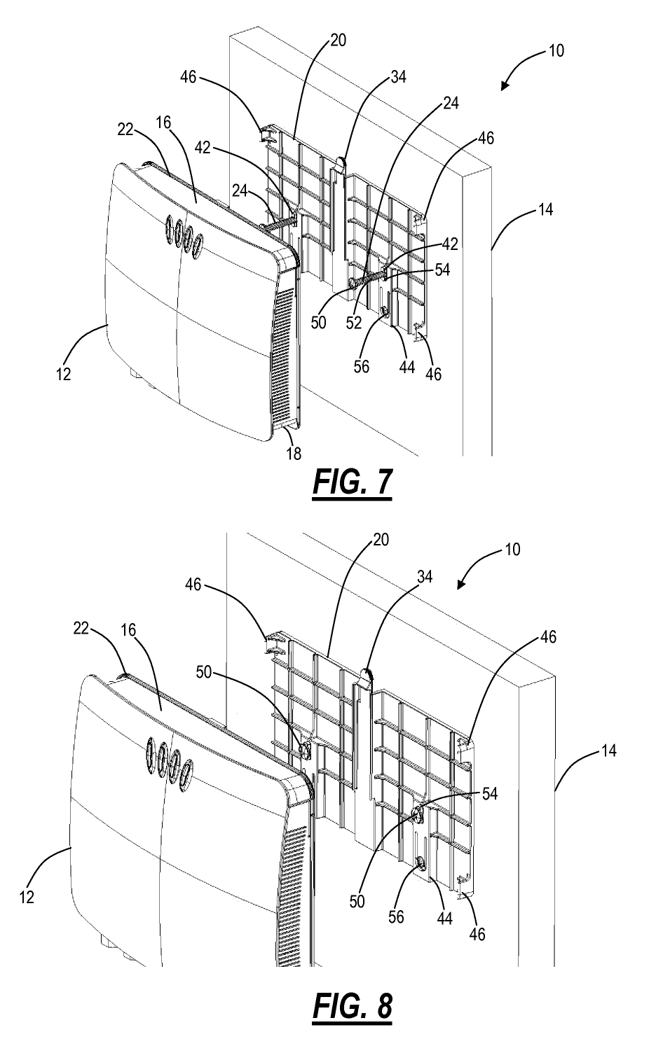

Referring to FIGS. 9 and 10, in an exemplary embodiment, front perspective diagrams illustrate an exemplary attachment operation of the device 12 to the bracket 20. Specifically, FIG. 9 illustrates the device 12 detached from the bracket 20, and FIG. 10 illustrates the device 12 attached to the bracket 20. As described herein, the bracket 20 includes the latch 34, shown in an exemplary embodiment at the top center of the bracket 20. Also, the base plate 22 includes the two notches 30 providing a catch mechanism for selectively locking the base plate 22 in position relative to the bracket. Here, the latch 34 snaps in place in the notch 30 locking device 12 in place on the bracket 20. The latch 34 includes the snap rib 35 that locks in place in the notch 30 as described herein. Removal of the device 12 can be achieved by exerting a force upon the latch 34 removing the latch 34 from the notch and taking the device 12 off the screws 24 and the bracket 20. Note, the latch 34 and the notch 30 keep the base plate 22 in place on the bracket 20 without providing significant load support of the device 12; instead the device 12 load is primarily supported by the screws 24. Also, as described herein, the bracket 20 includes various guide ribs 46, such as, for example, at the corners of the bracket 20. Note, the ribs 46 can be disposed at any location on the bracket 20 and are shown at the corners for illustration purposes. The latch 34 at the center of the bracket 20 and the ribs 46 provide a visual alignment mark collectively permitting a determination of the relative position of the base plate 22 relative to the bracket 20 when attaching the device 12 to the bracket 20.

The process of attaching the device 12 to the bracket 20 includes placing the device 12 such that the latch 34 on the bracket 20 in substantially centered on the device (FIG. 9) and such that the ribs 46 are substantially at ends of the device 12. Once positioned, the device 12 is moved such that the screw heads 50 engage the openings 26 in the base plate 22. In an exemplary embodiment, the openings 26 include a keyed holed configuration where the screw heads 50 are inserted into the openings 26 and then slide into a channel in the openings 26. Further, once slid into the channel, the latch 34 can engage the notch 30 thereby securing the base plate 22 to the bracket 20. In an exemplary embodiment to install the device 12 on the bracket 20, one just need to align the device 12 on visible markers on the bracket 20, slide the device 12 onto the screws 24 of the pre-installed bracket 20 and lock the device 12 in place by engaging the latch 34. For example, the guide ribs 46 can slide in predefined channels on the base plate 22 until the openings 26 engage the screw heads 50. In an exemplary embodiment, the assembly 10 includes an alignment feature through markers 48a, 48b on the base plate 22. This enables an installer to line up the device 12 with the bracket 20 and slide the device 12 into position. This may be used for blind alignment of the device 12 with the bracket 20.

Detaching the device 12 can include pressing or otherwise engaging the latch 34 to disengage the notch 30, sliding the device 12 to disengage the screw heads 50 from the channel, and removing the device 12 from the bracket 20. FIG. 10 illustrates the device 12 engaged to the bracket 20. The bracket 20 assures that the device 12 is well separated from a mounting surface for maximum convective heat transfer from the bottom of the device 12. Specifically, the ribs 46 are configured to define a space 60 between the mounting surface (e.g. the structure 14) and the base plate 22 of the device 12. The space 60 enables airflow to/from the device 12 for cooling. The bracket 20 is primarily designed to provide this space 60 while the screws 24 provide load handling of the device 12. Note, without the bracket 20, the device 12 would be substantially flat with the mounting surface without having the space 60 for heat transfer.

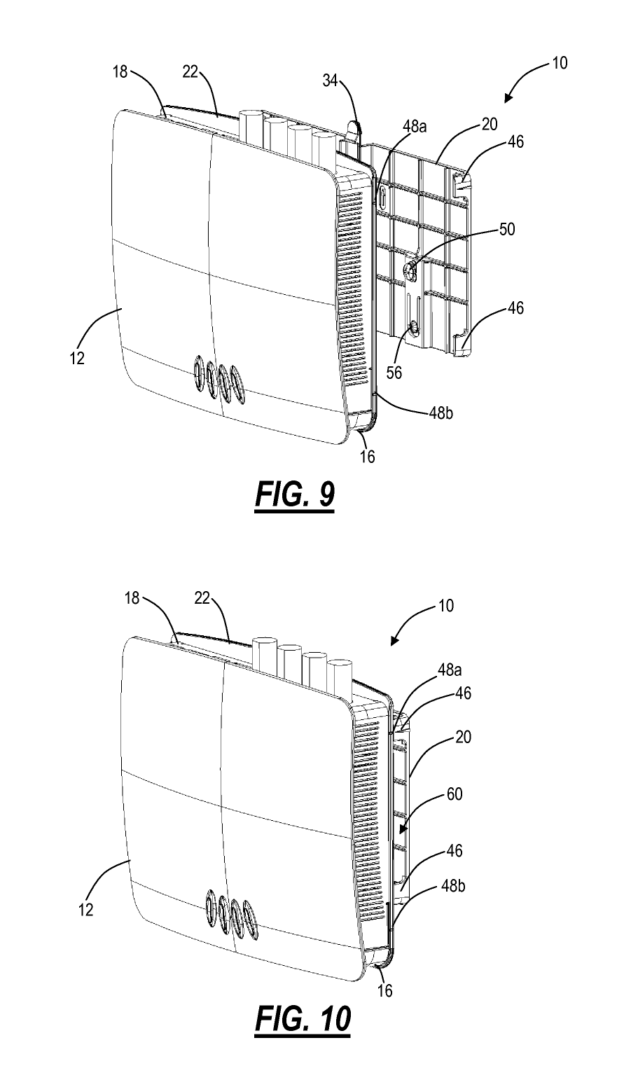

Referring to FIGS. 11 and 12, in an exemplary embodiment, front perspective diagrams illustrate an exemplary attachment operation of the device 12 on the bracket 20 in an opposite orientation as shown in FIGS. 9 and 10. Note, this exemplary embodiment utilizes the same bracket 20 configuration as in FIGS. 9 and 10, i.e. the bracket 20 is secured in the same manner. FIGS. 11 and 12 illustrated reorienting the device 12 such that the top side 16 and the bottom side 18 are opposite as in FIGS. 9 and 10. For example, to re-orient the device 12, a user may release the latch 34 and rotate the device 12 180° and reattach the device 12 to the bracket with no tools necessary. Thus, once the bracket 20 is attached to a surface, the device 12 may be attached to the bracket in two different configurations, either FIG. 10 or FIG. 12. Note, in another exemplary embodiment, the bracket 20 could include additional screws 24 such that the device 12 may be attached in four different configurations (i.e. each of FIGS. 1-4). The exemplary embodiments of FIGS. 9-12 illustrate the device 12 attached and secured to the wall or ceiling in bi-directional orientation on two screws via a traditional key-hole feature.

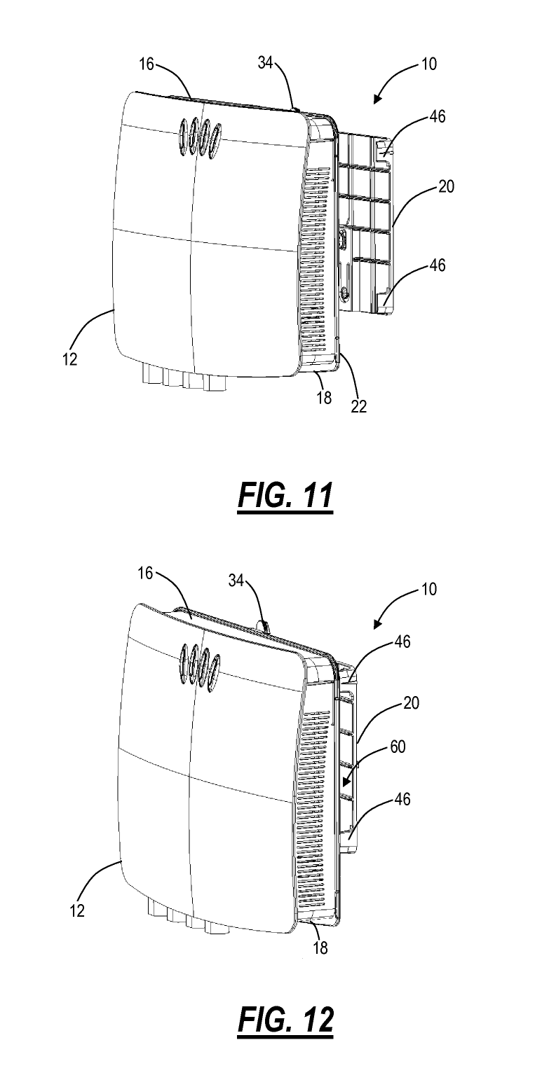

Referring to FIGS. 13 and 14, in an exemplary embodiment, back perspective diagrams illustrate the mounting assembly 10 of the present invention, highlighting the associated bracket 20 (with a portion thereof cut away for clarity) when detached (FIG. 13) and attached (FIG. 14) from the associated base plate 22 of the device 12. The base plate 22 includes channels 62 opposed to the guide ribs 46 of the bracket 20 and on which the guide ribs 46 slide for attaching/detaching the base plate 22 from the bracket 20. Also, the base plate 22 can include the notch 30 near the top side 16 and the bottom side 18 thereby enabling the base plate 22 to engage the bracket 20 from either direction. For example, the latch 34 can engage either of the notches 30 depending on the orientation of the device 12. FIGS. 13 and 14 illustrate the opening 26 as a two-way slotted key hole. Here, the screw head 50 inserts into a center hole of the opening 26 and then slides into one of the two-way slots. The screw head 50 is smaller than the center hole thus enabling the screw head 50 to enter the opening 26, but the screw head 50 is larger than the two-way slots such that the screw head 50 can only be removed through the center hole.

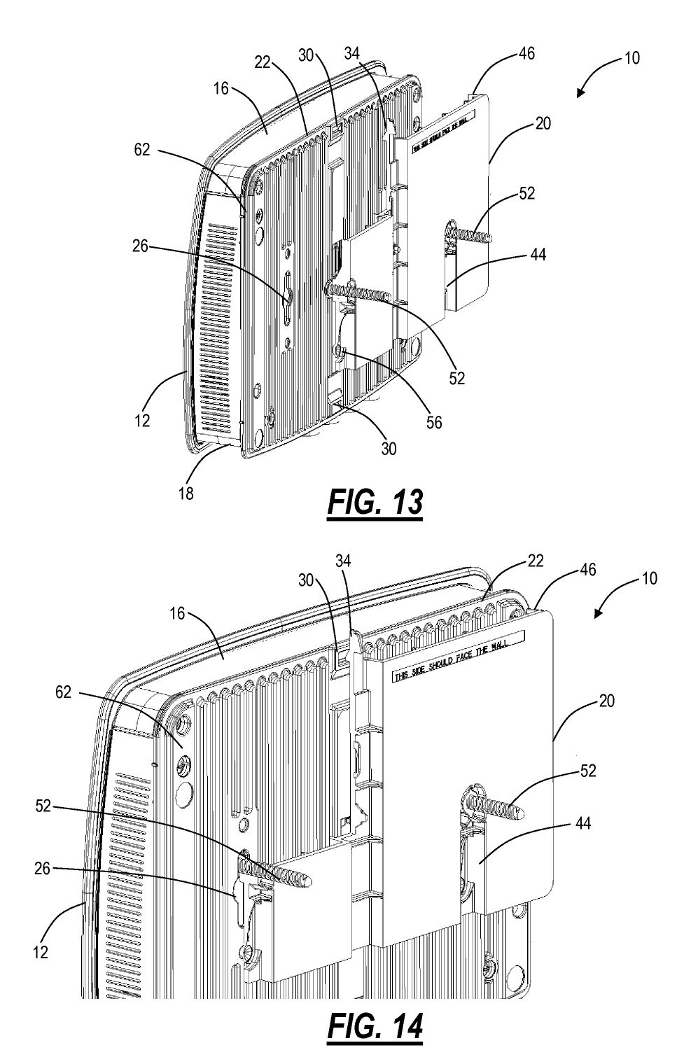

Referring to FIG. 15, in an exemplary embodiment, a back perspective diagram illustrates the mounting assembly 10 of the present invention, highlighting the associated bracket 20 when detached from the associated base plate 22 of the device 12. Here, the bracket 20 is disposed within a surface (not shown) by driving the screw's elongated shaft member 52 into the surface. As described herein, the screw head 50 extends out from the bracket's surface due to the raised portion 54 enabling the screw head 50 to fit within the opening 26. The opening 26 is shown for illustration purposes as a two-way keyhole, but the present invention contemplates any other configuration for selectively receiving and securing the screw head 50.

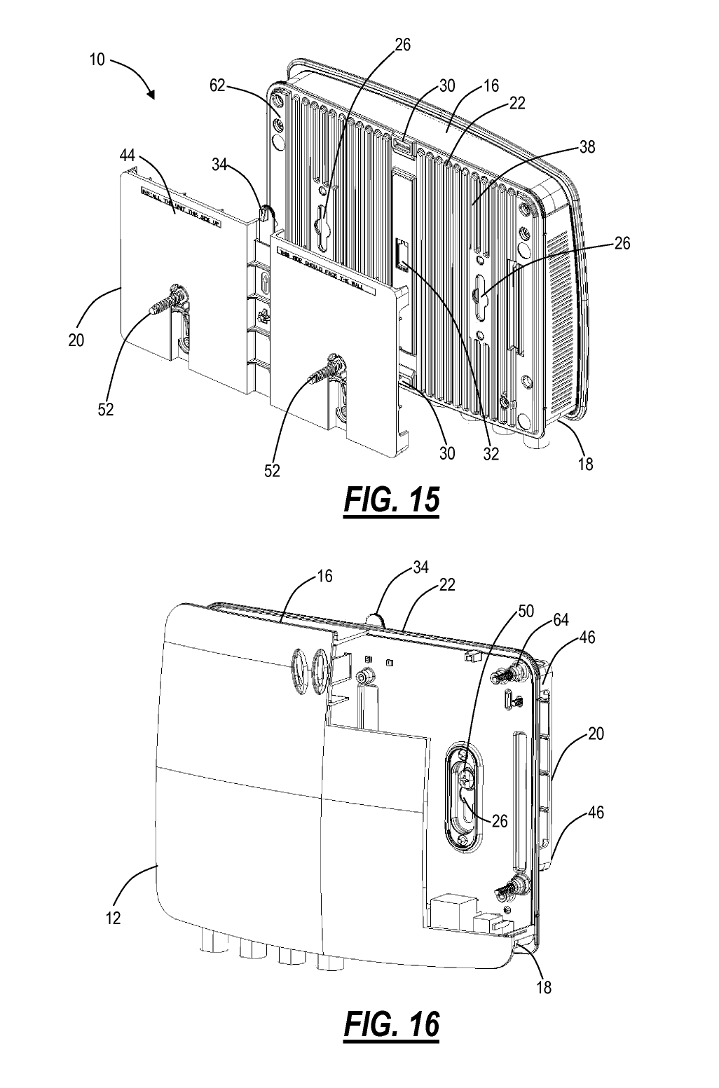

Referring to FIG. 16, in an exemplary embodiment, a front perspective diagram illustrates the mounting assembly 10 of the present invention, highlighting the device 12 (with a portion thereof cut away for clarity) with the base plate 22 engaged to the bracket 20. FIG. 16 illustrates inside of the device 12 and the opening 26 in the base plate 22. Specifically, the screw head 50 is shown engaged to the opening 26 and securely disposed in one of the key hole slots of the opening 26. Note, this engagement of the screw head 50 and the opening 26 provides support for the load of the device 12. Thus, the base plate 22 provides load support and heat convection (such as through the heat sink 38). Collectively, the screw head 50 and opening 26 cooperate with the guide ribs 46, the latch 34, and the notch 30 to maintain the base plate 22 to the bracket 20. For example, the load is handled by screw head 50 and opening 26, latch 34, and the notch 30 provide a locking mechanism, the guide ribs 46 create a defined space between the bracket 20 and the base plate 22 for heat transfer, and the notches 56 prevent rattling of the base plate 22 with the bracket 20. The base plate 22 can be secured to the device 12 through an attachment mechanism 64, e.g. screws, etc. In an exemplary embodiment, these attachment mechanisms 64 are located near the guide ribs 46 thereby providing additional stability as the guide ribs 46 provide a force against the base plate 22 at a point where the base plate 22 is secured to the remainder of the device 12.

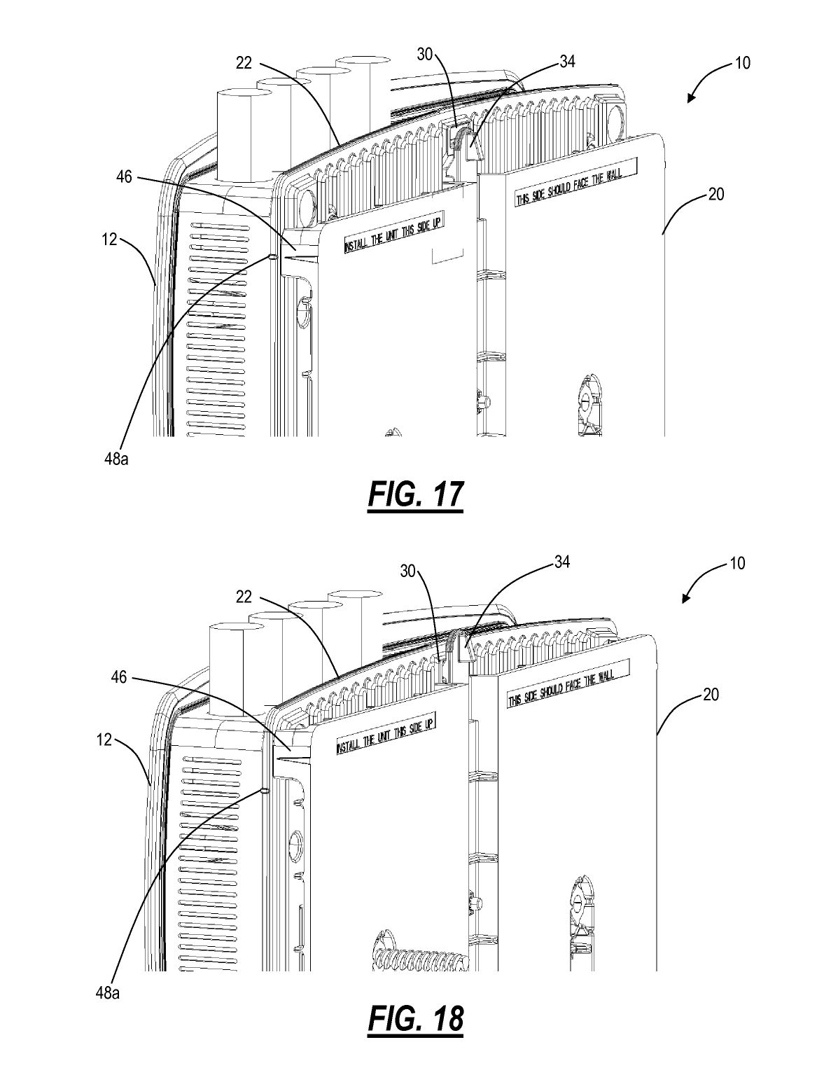

Referring to FIGS. 17 and 18, in an exemplary embodiment, a back perspective diagram illustrates the mounting assembly 10 of the present invention, highlighting the latch mechanism of the associated bracket 20 attaching to the associated base plate 22 of the device 12. In FIG. 17, the device 12 is aligned such that the ribs 46 abut the channel 62 and openings 26 receive the screw heads 50. To secure the device 12, the device 12 is slid such that the screw heads 50 are captured by slots in the openings 26 and such that the latch 34 engages the notch 30. In an exemplary embodiment, the latch 34 includes a ramped portion on a flexible tab. The ramped portion slides into the notch 30 with a slight bend in the flexible tab. Once fully engaged in the notch 30, the latch 34 is locked in by an end of the ramped portion. To remove the latch 34, force may be exerted to disengage the ramped portion and the device 12 may be slid out of the secure engagement.

The mounting assembly 10 has been described herein generally with respect to two screws 24 for the bracket 20 and the base plate 22. The two screws 24 prevent pivoting or rotating of the device 12, i.e. two screws 24 is the minimum to provide fixation of the device 12 in a rotational plane. However, the present invention contemplates one, three, or any number of screws with the mounting assembly. For example, a smaller device may only require one screw 24 along with the latch mechanism. Further, the device 12 is illustrated herein as sliding to engage the bracket 20. The present invention contemplates any engagement motion between the base plate 22 and the bracket 20 including a snapping engagement, rotating engagement, or any other linear or non-linear type of locking motion (arch, line, snap, semi-circle, etc.). Additionally, the openings 26 in the base plate 22 are described herein generally as a two-way key hole mechanism. The present invention contemplates other implementations of the openings, such as, for example, a four-way key hole, a multi-directional key hole, an aperture, a variable width opening to capture the screw head 50, and the like. Additionally, the openings 26 can include a flap that extends from the base plate 22 to capture the screw head 50. This flap may not include an opening in the base plate 22.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A mounting assembly for selectively securing a device to a structure, comprising:
a bracket;
a base plate selectively coupled to the bracket, wherein the base plate and the bracket are coupled together such that an air space is defined there between;
one or more screws each comprising a head portion and an elongated shaft member, wherein the elongated shaft member selectively engages an opening in the bracket to selectively engage to a structure thereby securing the bracket to the structure, and wherein the head portion selectively engages the base plate thereby coupling the base plate to the bracket; and
a device is attached to or integrally formed with the base plate.

2. The mounting assembly of claim 1, wherein the bracket comprises one or more arms configured and positioned such that convective heat dissipation occurs between the base plate and the structure.

3. The mounting assembly of claim 2, wherein the base plate comprises one or more grooves configured and positioned to slidingly receive the one or more spacers of the bracket.

4. The mounting assembly of claim 1, wherein the base plate comprises one or more spacers configured and positioned to further define the air space between the base plate and the bracket.

5. The mounting assembly of claim 4, wherein the bracket comprises one or more grooves configured and positioned to slidingly receive the one or more spacers of the base plate.

6. The mounting assembly of claim 1, wherein the bracket comprises a latch mechanism and the base plate defines a corresponding catch mechanism for selectively holding the base plate in position relative to the bracket.

7. The mounting assembly of claim 1, wherein the base plate comprises a latch mechanism and the bracket defines a corresponding catch mechanism for selectively holding the base plate in position relative to the bracket.

8. The mounting assembly of claim 1, wherein the bracket assembly and the base plate each comprise an alignment mark collectively permitting a determination of the relative position of the base plate relative to the bracket.

9. The mounting assembly of claim 1, wherein the head portion of the one or more screws selectively engages an aperture manufactured into the base plate thereby coupling the base plate to the bracket.

10. The mounting assembly of claim 1, wherein the bracket is secured to the structure such that the device is held in a plurality of orientations based upon positioning of the device on the bracket.

11. The mounting assembly of claim 10, wherein the device comprises at least one of cable ports, power ports, or antennas disposed on one or more sides of the device, and wherein the orientation of the plurality of orientations is selected based on any of the cable ports, the power ports, or the antennas relative to characteristics associated with the surface.

12. The mounting assembly of claim 10, wherein an orientation of the device is switchable to any of the plurality of orientations subsequent to the bracket being secured to the structure.

13. The mounting assembly of claim 1, wherein the bracket is sized and shaped such that no portion of the bracket protrudes beyond a perimeter of the base plate when the base plate is coupled to the bracket.

14. The mounting assembly of claim 1, wherein the bracket comprises one or more stops through which the one or more screws engages the bracket, the one or more stops determining a degree to which the head portion of the one or more screws protrudes above a surface of the bracket.

15. The mounting assembly of claim 1, wherein a load associated with the device is substantially maintained by the one or more screws when the device is selectively engaged to the bracket.

16. The mounting assembly of claim 15, wherein the bracket is configured to define the air space thereby providing convective heat dissipation between the device and the surface, and wherein the bracket is constructed of a plastic material.

17. The mounting assembly of claim 16, wherein the bracket comprises a latch mechanism and the base plate defines a corresponding catch mechanism for selectively holding the base plate in position relative to the bracket, and wherein the bracket provides substantially no load bearing of the device.

18. A method for selectively securing a device to a structure, comprising:
securing a bracket to a structure utilizing one or more screws each comprising a screw head, wherein each of the screw heads is configured to extend out a portion from a surface of the bracket;
positioning a device comprising a base plate with one or more openings disposed adjacent to the one or more screws;
engaging the device to the screw heads; and
securing the device to the bracket;
wherein the base plate and the bracket are coupled together such that an air space for convective heat transfer of the device is defined there between.

19. The method of claim 18, further comprising:
disengaging the device from the bracket;
repositioning the device in a different orientation to the bracket;
engaging the device to the screw heads; and
securing the device to the bracket.

20. A device, comprising:
a plurality of sides;
a base plate disposed to the plurality of sides and comprising a connection mechanism;
a bracket secured to a surface with one or more screws, wherein each of the one or more screws comprise a screw head that is offset from a surface of the bracket through a raised portion on the bracket;
wherein the connection mechanism is selectively engageable to the bracket through the screw heads in a plurality of orientations;
wherein at least one side of the plurality of sides comprises a cable port such that an orientation of the plurality of orientations is selected based upon a location of the cable port; and
wherein the base plate and the bracket are coupled together such that an air space for convective heat transfer is defined there between.
